(19) United States
(12) Patent Application Publication
(10) Pub. No.: US 2010/0183441 A1
(43) Pub. Date: Jul. 22, 2010

(54) Un-symmetrically designed windmill rotor for generating maximum electricity

(76) Inventor: Young Il Choi, Burbank, CA (US)

Correspondence Address: Young II, CHOI, 305 E. Balencia Ave. #P, Burbank, CA, 91502, US

(21) Appl. No.: 12/321,333

(22) Filed: Jan. 16, 2009

(51) Int. Cl. F03D 1/06

(52) U.S. Cl. 416/117

(57) ABSTRACT

A windmill rotor for horizontally rotating windmill for efficiently generating electricity is provided. The windmill rotor according to current application is comprised of a vertical axis rotor, which is comprised of an armature and two concaved wings which are attached at each end of the armature. Pluralities of long slits are developed perpendicularly to the armature on the outer surface of each wing. On each slit, one blade is attached to one long side of the slit with a hinge and a ribbon spring to enable the blade flapping, inwardly of the wing, according to the wind. The armature includes an elongated slot at the center to enable the armature shift back and forth longitudinally for a greater efficiency.

### 1. FIELD OF THE INVENTION

Current application relates to energy producing windmill's rotor, especially relates to a windmill rotor that is designed to maximize the rotating momentum while minimizing resistance of wings against the wind.

### 2. BACKGROUND OF THE INVENTION

Harnessing the wind for generating electricity is well known technology and been commercialized for long time. And lots of efforts were focused on improving the performance of the windmills. However, only few of them are commercialized used these days. For example, none of the horizontally rotating wind mills are not commercialized and only one type of vertically rotating windmill is commercialized. The inventor focused on the reason why most of the horizontally rotating windmills are not commercialized and found that there remain some vacancies to be improved. It is the first object of the present invention to provide a vertical axis rotor, having increased efficiency.

### DESCRIPTION OF THE PRIOR ART

U.S. Pat. No. 7,360,995 to Suzuki illustrates a vertical axis windmill in which a support frame is provided as a wind power dam to form a plurality of shaft-installation sections, and in which a plurality of vertically long blades each of which has a tilted part at the upper and lower ends respectively are disposed in multi-levels to improve wind-receiving power thereby providing a wind power generator with low installation cost and increased total power generation per a certain area.

U.S. Pat. No. 6,960,062 to Blank, et al. illustrates a frost-resistant windmill is disclosed to provide supplemental power supply for use preferably in large cities. The frame of the windmill carrying a plurality of blades is made hollow defining a serpentine internal air pathway adapted for introduction of warm air from an external source to prevent freezing when used during winter months.

U.S. Pat. No. 6,379,115 to Hirai illustrates a windmill includes a freely rotate-able revolution shaft, a plurality of pairs of pivotal support rods provided at the revolution shaft, and wind receiving blades respectively and rotatably set between the pivotal support rods with wind receiving blade shafts.

U.S. Pat. No. 5,997,252 to Miller illustrates a wind driven electrical power generating apparatus includes an armature. The apparatus also includes a wing secured to the armature. The wing defines a pocket having a hub end and an outer end. The width of the pocket monotonically increases from the hub end to the outer end. Moreover, the depth of the pocket monotonically increases from the hub end to the outer end.

U.S. Pat. No. 5,195,871 to Hsech-Pen illustrates a windmill includes a plurality of fan blade units pivotally mounted in a central vertical trans-mission shaft each unit having a right-leaf vertical fan blade and a left-leaf horizontal fan blade.

U.S. Pat. No. 5,163,813 to Schlenker illustrates a power-producing will. A unique paddle configuration is provided which provides first and second wind-capturing cavities for increasing the total energy conversion efficiency of the wind to electromotive energy.

U.S. Pat. No. 5,126,584 to Ouellet illustrates a windmill having a stator and a rotor. The rotor has the shape of a long convex blade having sharp edges and being symmetrical with respect to its longitudinal axis.

U.S. Pat. No. 4,926,061 to Arreola, Jr. illustrates a windmill of two designs, both aesthetically acceptable and operational without noise pollution, having a rotatable vertical shaft with either three or four wind traps consisting of a pair of concave vanes.

U.S. Pat. No. 4,508,972 to Willmouth illustrates an armature lift windmill. Airfoils are secured to the frame of a vertical axis windmill to provide vertical lift to a rotatable vertical shaft and to armatures of electrical generators, thereby eliminating friction between each armature and its end bearing as well as between the vertical shaft and its end bearing.

U.S. Pat. No. 4,415,311 to Grana, et al. illustrates a vertical shaft 11 has several equally spaced blades 14 mounted thereon. Each blade consists of an inboard section 15 and an outboard section 16 skew hinged (17) to the inboard section. The inboard sections automatically adjust their positions with respect to the fixed inboard sections with changes in velocity of the wind. This windmill design automatically governs the maximum rotational speed of shaft 11.

U.S. Pat. No. 4,402,650 to Jones illustrates a wind-operated rotor, including at least one or more horizontal propellers, mounted along a vertical shaft of a generator secured upon a tower, so as to generate electrical power; a hollow cone secured in opposite directions at the outer ends of each propeller, and means to shift the propeller outwardly at their ends which catch the wind.

U.S. Pat. Nos. 4,406,584 and 4,203,707 to Stepp illustrates a windmill of the vertical axis type having a plurality of circumferentially and radially outwardly spaced rotatably mounted vanes vertically parallel to the axis shaft.

U.S. Pat. No. 4,019,828 to Bunzer disclosed a wind driven apparatus that is in the form of a windmill. The apparatus includes a base mounted for rotation, preferably about a vertical axis, and along its periphery carrying a series of cones each with an open mouth for receiving air or other fluid, to rotate the base about its axis.

Among the prior arts, the U.S. Pat. No. 4,402,650 is most close to current application. However, even his invention has does not have many features to maximize the un-symmetric movement of the armature as shown in the current application.

### SUMMARY OF THE INVENTION

Harnessing the wind for generating electricity is well known technology and been commercialized for long time. And lots of efforts were focused on improving the performance of the windmills. However, only few of them are commercialized used these days. For example, none of the horizontally rotating wind mills are not commercialized and only one type of vertically rotating windmill is commercialized. The inventor focused on the reason why most of the horizontally rotating windmills are not commercialized and found that there remain some vacancies to be improved. It is the first object of the present invention to provide a vertical axis rotor, having increased efficiency. A windmill rotor for horizontally rotating windmill for efficient generating electricity is provided. The windmill rotor according to current application is comprised of a vertical axis rotor, which is comprised of an armature and two wings which are attached at each end of the armature. Pluralities of long slits are developed perpendicular to the armature on the surface of each wing. On each slit, one blade is attached to one long side of the slit with hinges to enable the blade flapping, inwardly of the wing, according to the wind. The armature includes an elongated slot at the center to enable the armature shift back and forth longitudinally for a greater efficiency.

### BRIEF DESCRIPTION OF THE DRAWINGS

FIG. 1 is a perspective view of a rotor of a windmill electricity generator according to current invention showing being rotated by a blowing wind.

FIG. 2 is a cross-sectional top view of a wing according to current application.

FIG. 3 is a schematic top plan view of the rotor according to current invention showing the momentum balance how the armature starts rotating by a blowing wind.

### DETAILED DESCRIPTION OF THE PREFERRED EMBODIMENT

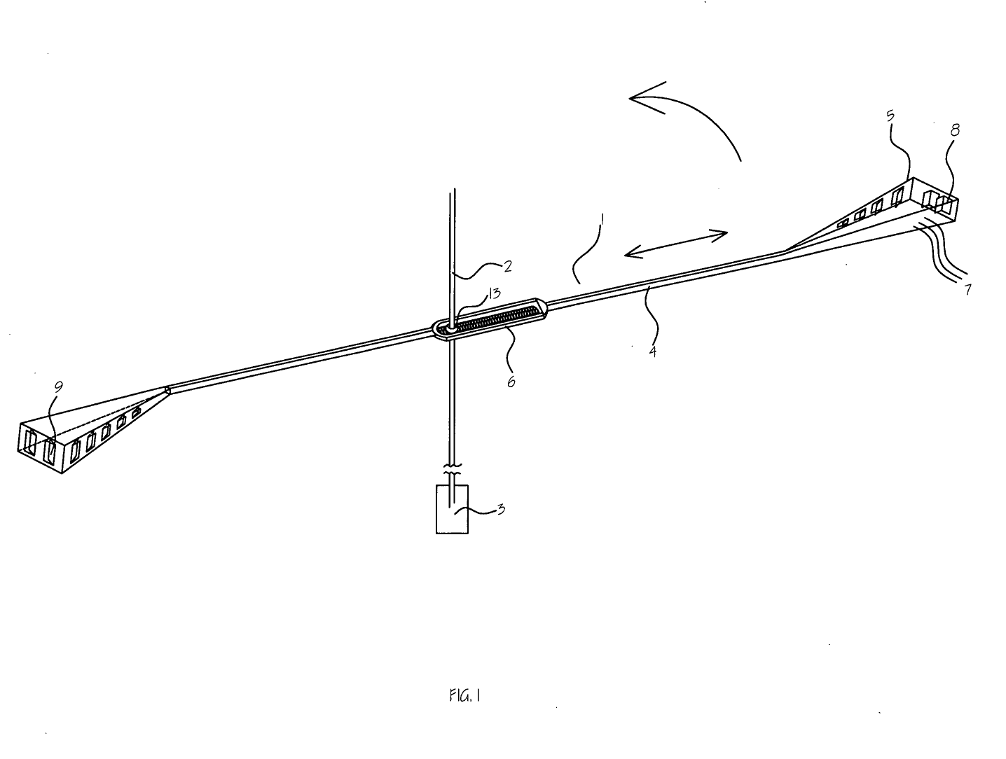

FIG. 1 is a perspective view of the rotor (1) of a windmill according to current invention. The armature (1) is rotatably attached to a vertical rod (2). The vertical rod (2) is connected to an electric generator (3). The rotor (1) is comprised of an armature (4) and two concave wings (5). Each of the two concave wings (5) is attached at each end of the armature (4) along the parallel axis of the armature (4), facing opposite directions. The armature (4) includes an elongated slit (6) so as to shift back and forth longitudinally, once during each rotation, so that, when the open-mouthed end of the concave wing (5) faces the wind, it is located along a longer pivoting arm L, and the tapered end of the other wing facing the wind is on a shorter pivoting arm 1, so that there is a still greater proportional difference between the drive force of the cone open end to the cone tapered end, for a greater efficiency. Though similar idea was introduced by Jones in the U.S. Pat. No. 4,402,650, it still has draw-backs that the cross sectional area of the front and rear of the tapered cones are the same. Therefore, his invention failed to teach how to realize his idea.

The inventor of the current application studied and experimented for long years and found that not only the shape of the wings (5) but the cross-sectional area of each wing (5) should be changed according to their direction against the direction of the wind (7).

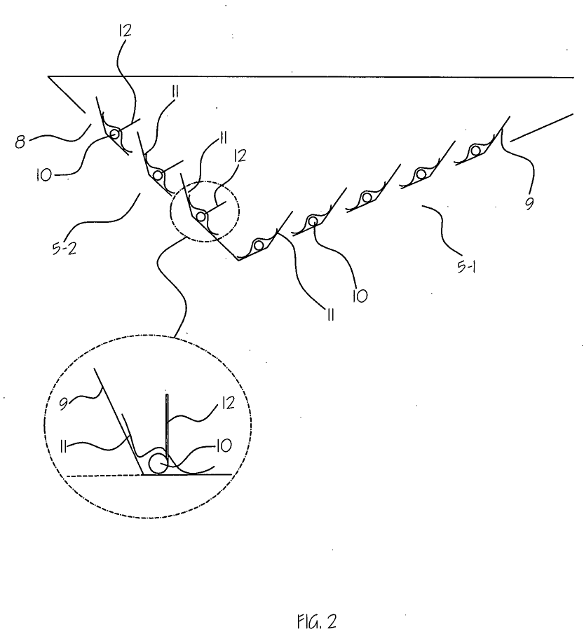

FIG. 2 is a cross-sectional top view of a wing (5) according to current application. The cross sectional top view of the concave wing (5) has asymmetric triangular shape. The side (5-1) connected to the armature (4) is longer than the other side (5-2) that constitute the tip of the armature (4). In addition to this asymmetric shape, pluralities of long slits (8) are developed perpendicularly to the armature on the outer surface of each wing (8). On each slit, one blade (9) is attached to one long side of the slit (8) with a hinge (10) and a ribbon spring (11) to enable the blade flapping, inwardly of the wing, according to the wind. In addition to them, one stopper (12) is welded perpendicularly to the inside of the short side (5-2) of the wing (5) to stop the blade (9) from totally folded inwardly. On the long side (5-1) there are no stoppers (12).

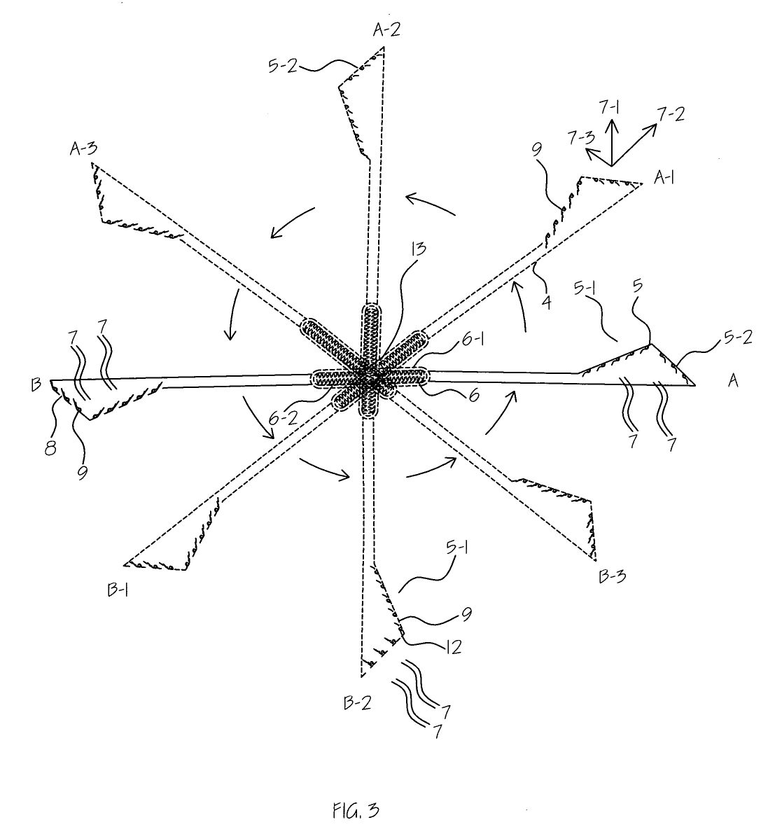

FIG. 3 is a schematic top plan view of the rotor (1) according to current invention showing the momentum balance how the armature (4) starts rotating by a blowing wind (7).

When the rotor of the current invention faces a wind (7) perpendicularly, the wing (5) at the position ‘A’ faces the wind perpendicularly. Then the wind (7) and the ribbon springs (11) push the blades (9) to ‘closed’ position, at which the blades (9) block the slits (8). Meanwhile, the wind (7) pushes the blades (9), which are attached on the wing (5) at position ‘B’, to open the slits (8). So, the force applied on the wing (5) at position ‘A’ is maximized and the resistance against the wind caused by the wing (5) at position ‘B’ is minimized.

As the armature (4) turns and the wings (5) approach the positions ‘A-1’ and ‘B-1’ while the wind (7) maintains its direction, the wind (7) pushes the short side (5-2) of the wing (5) in position ‘A’ perpendicularly.

Then, the pushing force (7-1) generated by the wind (7) is divided into two portion of a force that (7-2) drags the wing (5) at the position ‘A-1’ to the outer direction from the vertical rod (2) and a force (7-3) that rotates the wing (5) at the position ‘A-1’ around the vertical rod (2). Meanwhile, blades (9) on the wing (5) at the position ‘B-1’ open the slits (8) to minimize the drag force.

Two springs (6-1) and (6-2), which are installed inside of the elongated slit (6), and a bearing (13) enables the armature (4) slide to one direction lead by the force (7-2) that pushes the wing (5), at the positions ‘A-1’ to ‘A-2’, to outer ward. The force (7-2) is minimized when the wings (5) locate at the positions ‘A-2’ and ‘B-2’, i.e., parallel to the wind (7) direction.

At this position, the short side (5-2) of the wing (5) at the position ‘A-2’ and the long side (5-1) at the position ‘B-2’ are closed. Meanwhile, the blades (9) on the long side (5-1) of the wing (5) at the position ‘A-2’ and the short side (5-2) of the wing at the position ‘B-2’ is open.

Though the blades (9) of the short side (5-2) of the wing (5) at the position ‘B-2’ is open, the stoppers (12) hold the blades (9) at a rectangular position to the short side (5-2). At this position, the wind (7) reflected by the blades (9) pushes the wing (5) to anti-clock wise in the FIG. 2. At this position, the blades (9) on the long side (5-1) of the wing (5) at the position ‘B-2’ blocks the slits (8) and helps the wind push the wing (5) to the anti-clock wise.

Therefore, the rotor for electricity generation according to current application only can start to turn horizontally even though only two wings are attached on one rotor.

All the other rotors of the prior art, which has two wings or cups or blades on a rotor, can not start turn when the wind blows parallel to the rotor.

What is claimed is:

1. A horizontally rotating rotor for a windmill type electricity generator, which is rotatably attached to a vertical rod, is comprised of;
an armature that is comprised of;
an elongated slit,
and
two springs, which are installed inside of the elongated slit,
and
a bearing enables the armature so as to shift back and forth longitudinally with combination of the two springs; once during each rotation, so that, when the open mouthed end of the concave wing faces the wind, it is located along a longer pivoting arm, and the tapered end of the other wing facing the wind is on a shorter pivoting arm,
and
two concave wings, each of which is attached at each end of the armature along the parallel axis of the armature, facing opposite directions,
and
the side of each concave wing which is connected to the armature is longer than the other side of each concave wing that constitute the tip of the armature,
and
pluralities of long slits which are developed perpendicularly to the armature on the outer surface of each wing,
and
pluralities of blades, each of which is attached to one long side of the slit with a hinge and a ribbon spring to enable the blade flapping, inwardly of the wing,
and
pluralities of stoppers each of which is welded perpendicularly to the inside of the short side of the wing to stop the blade from totally folded inwardly.
